(19) United States
(12) Patent Application Publication
(10) Pub. No.: US 2010/0194115 A1
(43) Pub. Date: Aug. 5, 2010

(54) Conversion System Of Off-Shore Wind Energy Suitable For Deep Water

(75) Inventors: Martin Jakubowski, Frankfurt am Main (DE); Silvestro Caruso, Genova (IT)

Correspondence Address: GIBSON & DERNIER LLP, 900 ROUTE 9 NORTH, SUITE 504, WOODBRIDGE, NJ, 07095, US

(73) Assignee: BLUE H INTELLECTUAL PROPERTIES CYPRUS LIMITED, Nicosia (CY)

(21) Appl. No.: 12/679,408

(22) PCT Filed: Sep. 22, 2008
(86) PCT No.: PCT/IB2008/002462

§ 371 Date: Apr. 14, 2010

(30) Foreign Application Priority Data
Sep. 24, 2007 (IT) TO2007A000666

(51) Int. Cl. F03D 9/00

(52) U.S. Cl. 290/55

(57) ABSTRACT

System for converting wind in deep water, stabilised through blocked hydrostatic pressure, comprising a group of rotors with horizontal axis provided with two blades, accommodated in a nacelle, one permanent magnet generator, at least one transformer and at least one rectifier, as well as further auxiliary components, a group for anchoring the system onto the sea floor, a subsystem for transmitting power from the rotor group to the generator and a subsystem for transmitting electrical power from the submerged body to the dry land and characterised in that said electrical energy generator, transformer, rectifier and said auxiliary components are located in a submerged body beneath the water level.

An object of the present finding is a system for converting offshore wind energy in water deep at least fifty meters, provided with an electrical energy generator and auxiliaries located in a body submerged below the water level and stabilised through blocked hydrostatic pressure.

In order to increase and optimise the use of wind energy converters for generating electrical energy, conceived have been the so-called offshore wind plants, located in the sea environment, wherein the number of applications is growing steadily. The advantages of such applications, alongside the wide availability of space, consist in the ideal and more constant wind conditions and in the substantial absence of noise pollution and visual impact.

The current offshore wind energy plants technologies are characterised in that they transpose the known fixed installation concepts known for installation on the dry land to the sea environment, fixing the wind energy converter tower always in a fixed manner on the or into the sea floor.

From an economical point of view, these solutions are feasible only up to the depth of about 50 m, after which this approach becomes economically inadvisable in that the anchorage part onto/into the sea floor implies using a large amount of materials and facilities, the connection to the sea floor being a fixed extension of the wind energy converter tower.

Furthermore, the application of these fixed installation technologies requires, the availability of enough windy areas with shallow waters, while in most of the seas worldwide, around the coasts, the sea floor deepens rapidly thus it is not possible to install such systems far off the coast and avoid the visual and noise impacts. Having wind energy plants too close to the coast o implies risks related to environmental impact.

An object of the finding subject of the present invention is that of defining a wind energy conversion system located in a sea environment but which is not affected by the abovementioned difficulties and can be used in deep water reducing is environmental impact to the minimum. A further object is that of increasing the productivity of the wind energy systems, being able to arrange them in sea water with high windiness and in particular with wind that is relatively more constant and hence with less turbulences with respect to the wind on the dry land.

The finding object of the present invention overcomes the abovementioned technical drawbacks in that it is a deep water wind energy conversion system substantially comprising five subsystems:
i. a rotor group with horizontal axis provided with two blades, arranged in a nacelle;
ii. a permanent magnet generator with at least one transformer at least one rectifier, as well as further auxiliary components;
iii. a group for anchoring the system to the sea floor thus ensuring the complete stability of the unit though reducing the loads coming from the waves and from the wind;
iv. a system for transmitting power from the rotor group located about 80 m above the sea level to the generator located about 10 m below the sea level;
v. a system for transmitting electrical power from the submerged body to the dry land

and characterised in that said conversion system is stabilised by means of a blocked hydrostatic pressure and in that said electrical energy generator, transformer, rectifier and said auxiliary components (that is the generation ii subsystem) are located in a body submerged below the water level, contributing in this configuration to reducing the centre of gravity, thus optimising both the construction for operation purposes, and the transport as well as the installation of the system in deep water and hence reducing the cost of the energy produced.

These and other advantages shall be clear from the detailed description of the invention specifically referring to drawings 1/7 to 7/7 represented in which is an absolutely non-limiting preferred embodiment of the present finding.

In particular:

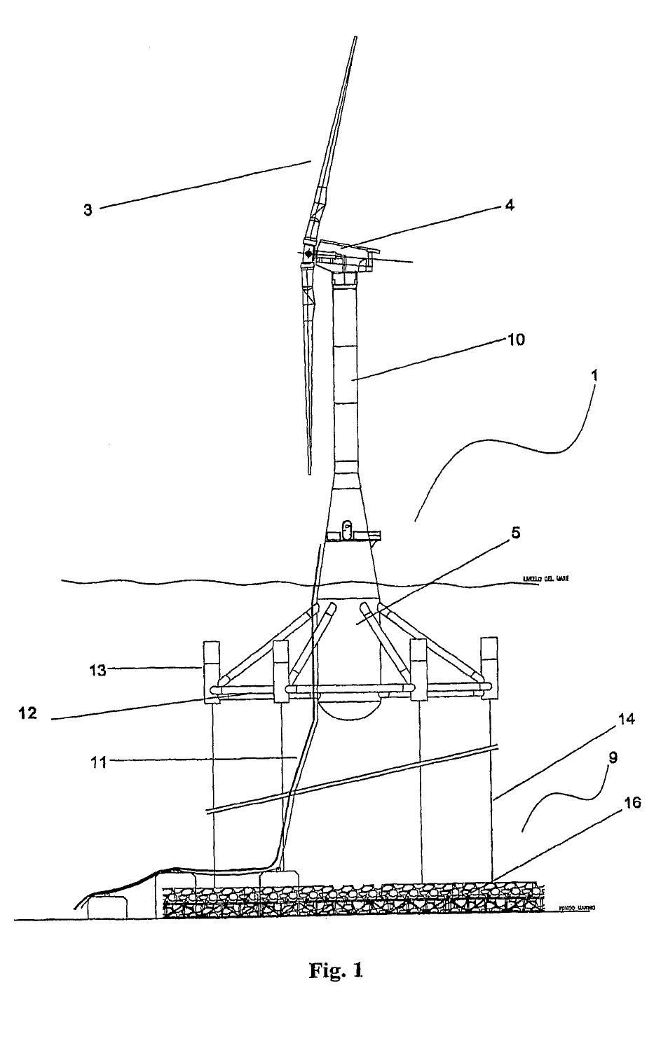

FIG. 1 represents a diagram of the general configuration of the system;

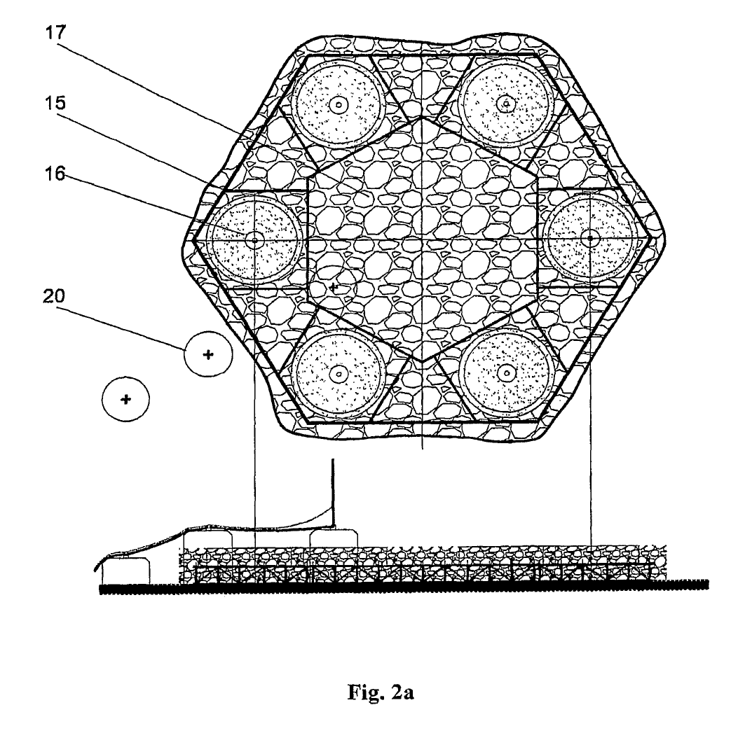

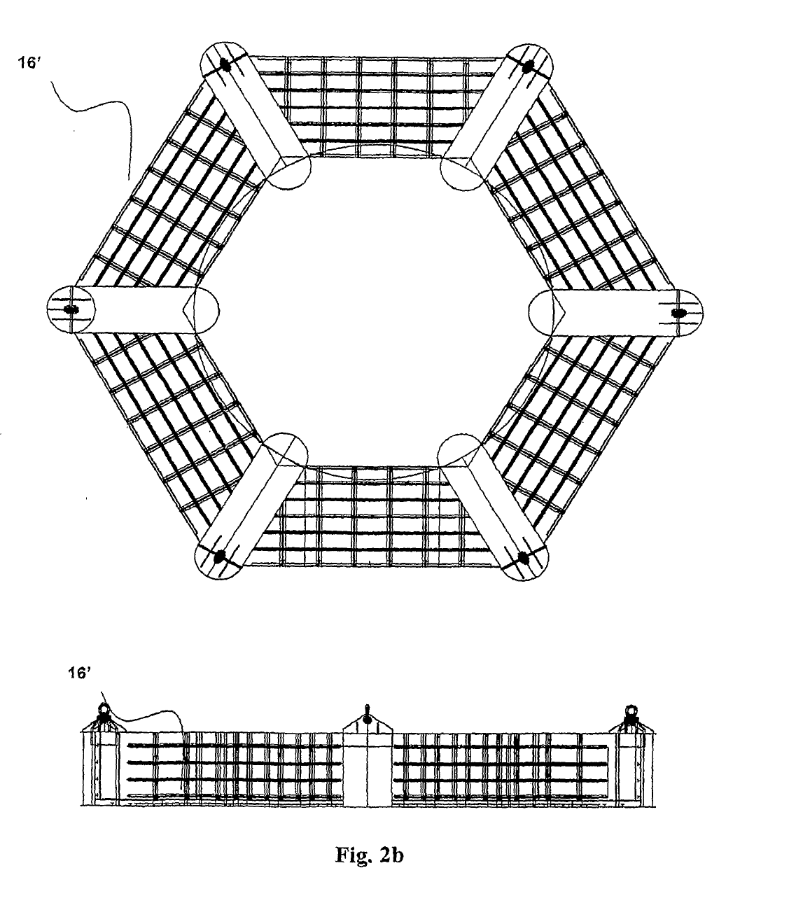

FIG. 2 represents the plan view of the anchoring system, according to two different embodiments (FIG. 2a, FIG. 2b);

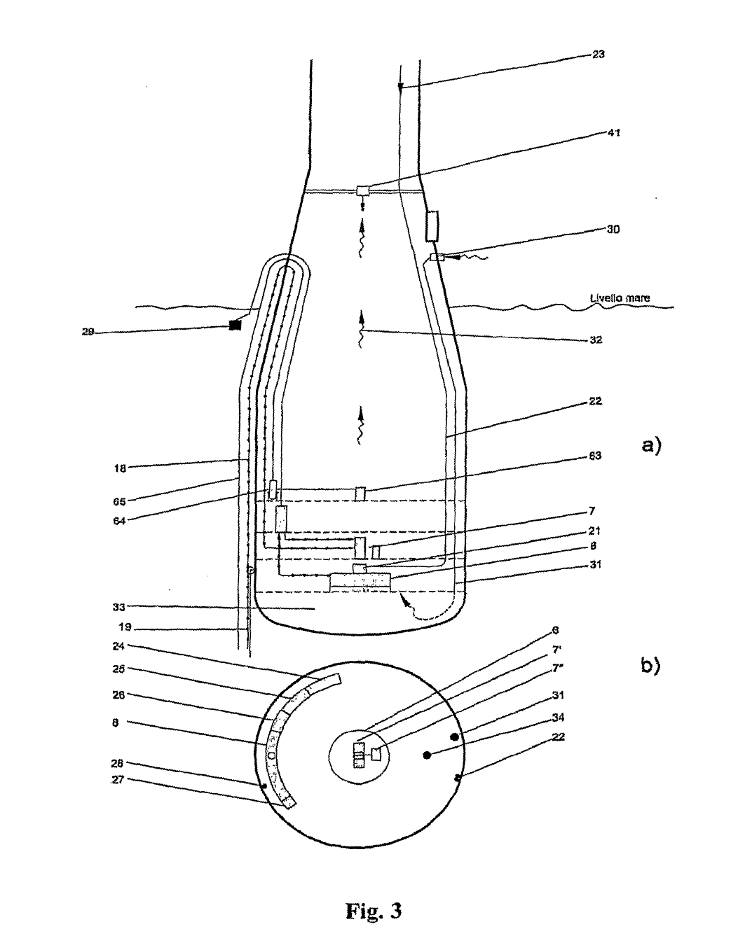

FIG. 3 shows, in perspective (FIG. 3a) and plan (FIG. 3b) view, the diagram of the submerged body;

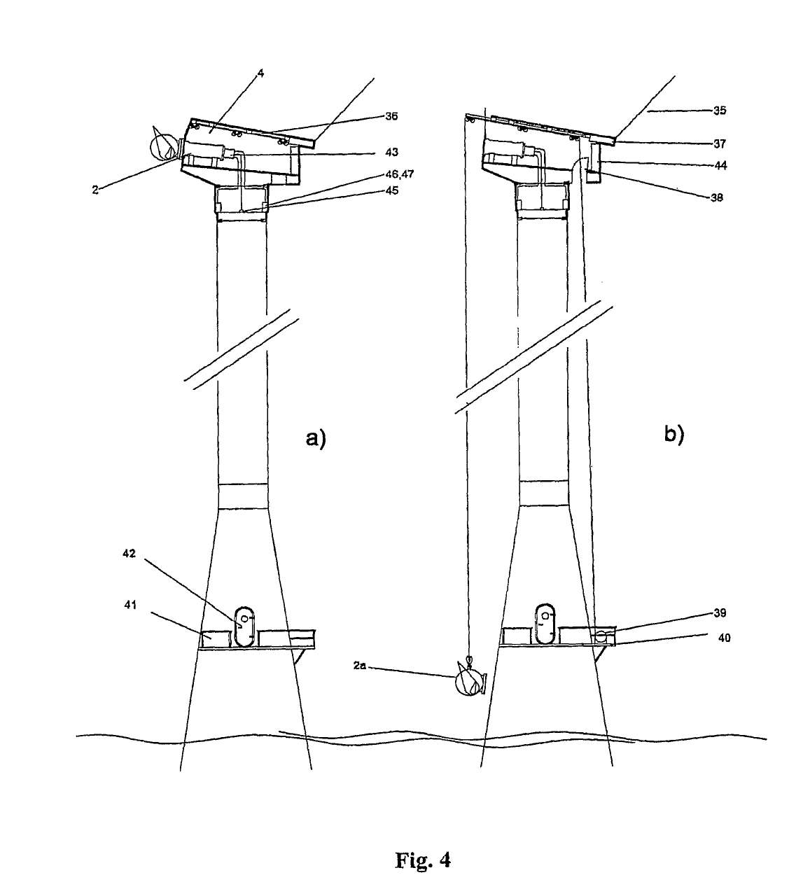

FIG. 4 represents the diagram of the nacelle of the system under normal conditions (FIG. 4a) and in maintenance conditions (FIG. 4b) wherein shown are means for hoisting o and/or lowering the rotor group for mounting and maintenance purposes;

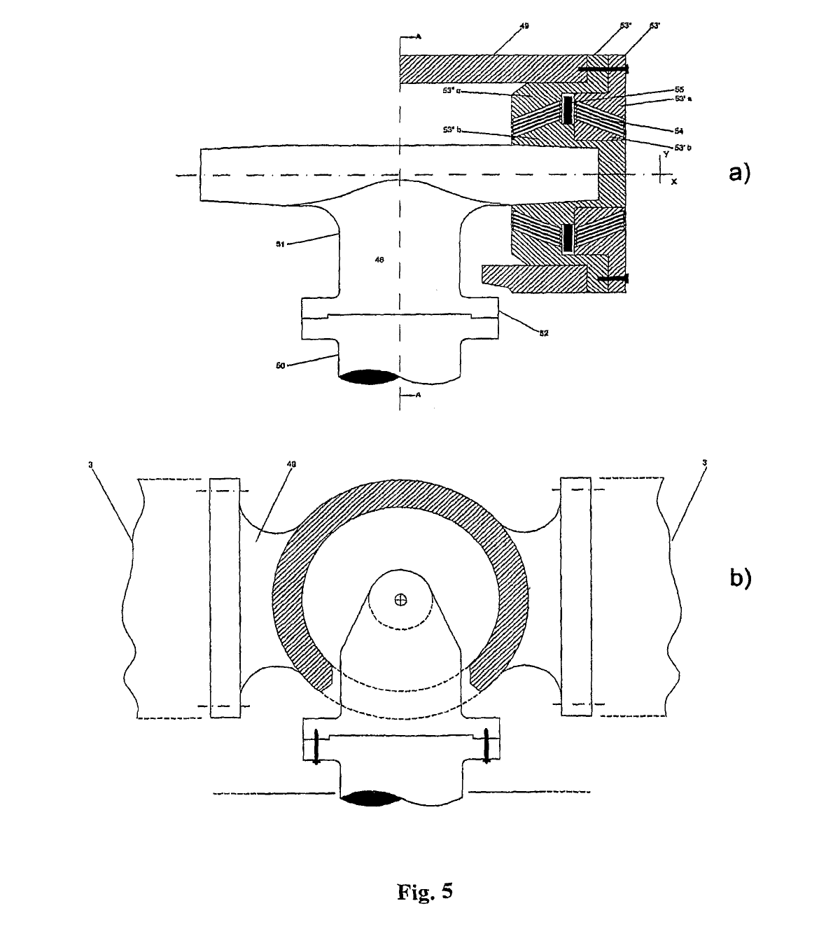

FIG. 5 shows in view (FIG. 5a) and in section (FIG. 5b) the connection between the shaft and the hub;

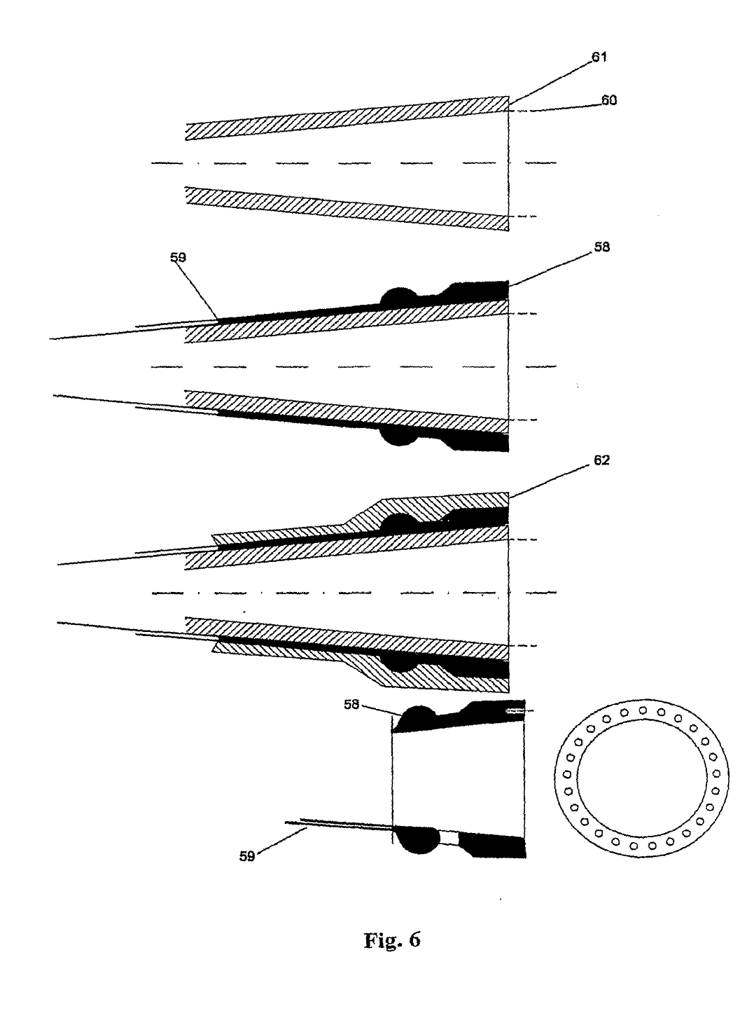

FIG. 6 shows an insert of the root of the blade.

Referring to the abovementioned figures, the wind energy conversion system (1) comprises a rotor group with horizontal axis (2) provided with two blades (3), accommodated inside a nacelle (4), a submerged body (5) accommodated inside which is the permanent magnet generator (6), at least one transformer (7) and at least one rectifier (8), a subsystem (9) for anchoring the entire system to the sea floor, a subsystem (10) for transmitting power from the aerial rotor group to the generator located below the sea level and a subsystem (11) for transmitting the electrical power from the submerged body to the dry land.

The anchoring subsystem, being the suitable device for deep water installation, is of particular importance from structural, transport and laying points of view. The anchoring subsystem comprises a six-legged structure (12) anchored to the sea floor by means of elements (14), such as chains, ropes or tubular bars tractioned by the hydrostatic pressure. The connection between the structure (12) and the elements in traction (14) is performed by hydraulic jacks with mechanical ratchet (13) whose purpose is to monitor and adjust the tension. Referring to FIG. 2, the anchoring of the elements in traction (14) to the sea floor is performed by a plurality of blocks made of reinforced concrete (16) filled with ballast material. Such blocks are arranged inside a steel template (15), surrounded both internally and externally by stones (17). It should be observed that due to their “cup” is shape, the concrete blocks can be drawn to the site by means of floating, thus facilitating their transport in loco. According to another embodiment, the anchoring subsystem comprises a single counterweight (16′) provided with at least one cavity, also transportable to the site by floating and ballastable on site.

Advantageously, it is possible to organise the transport of the entire wind energy system towards the site according to a “self-installing” procedure. Such procedure can be structured in the following steps:
I. assembling the platform (12), comprising hydraulic jacks (13) and re-wound traction means (14), as well as the related (16) at the worksite;
II. moving the system described at point I towards a dock at such a depth to allow to allow the installation of the wind energy system (1);
III. transporting the system identified by the preceding steps to the identified site;
IV. unloading the base (16) “in situ”.

In detail, the first step involves assembling the subsystem made up of: platform (12) and base (16) with the relative connection of the traction means (14) through hydraulic jacks (13) in such a manner to complete the anchoring subsystem (9). In such step, the traction means (14) are completely re-wound in their is respective seats, hence allowing the operation to be performed at a zone of the worksite in proximity to the coast. In the second system, the subsystem thus defined is transported towards a dock at such a depth to allow the installation and the engagement of the relative wind energy system (1). Occurring in the third step is the final transport towards the identified final site, while occurring in the final step is the unloading of the base (16) up to the sea floor by means of the relative hydraulic jacks (13), which in turn release the traction means (14).

The subsystem for transmitting electrical energy (11) consists in an electrical cable (18) which, starting from the electrical panels, extends along an electrical cable support (19) until it reaches, guided by special electrical cable blocks (20), in the undersea cable which continues up to the dry land, where it will end up in a substation for transforming and distributing towards the high and medium voltage line or up to a substation on a platform with a blocked hydrostatic pressure located in the site from which a high voltage undersea cable transports energy to the dry land, up to point of connection.

As already mentioned, the main characteristic of the finding o consists in a submerged body (5), having a diameter of 8÷12 m, accommodated inside which are all the components for producing and transforming electrical energy. Referring to FIG. 3, the body (5), having a shape similar to the one of a bottle, is almost entirely submerged below the sea level, except for the neck. This is obtained by creating an “engine room” structure therein, with all the components, as well as a ballast compartment, arranged in the lower part of the body, in such a manner to lower its centre of gravity to the maximum and increase its stability during transport and installation. The advantages obtained through this innovative engine room architecture below the sea level lie in the fact that the access to the main components for producing electrical energy is very easy. As a matter of fact, the later not being located, height-wise, at the level of the rotor group, it is possible to avoid using expensive crane vessels both during the installation and maintenance step. Furthermore, the heat discharge corresponding to power drops of the electrical components, especially the rectifier and main transformer, is facilitated by the fact that the body is submerged in the sea water with an almost constant low temperature even during summer.

Furthermore, this architecture allows, a safe installation process given that the system has allow centre of gravity with respect to the centre of thrust, due to the position of the components and the supplementary use of ballast which is easy to use and remove in deep sea.

As mentioned, the machines and the electrical apparatus are located in the lower portion of the wide submerged body. The main machine for producing electrical energy is a permanent magnet generator (6), of about 4÷5 m in diameter (about half the diameter of the submerged body), which is driven by a hydraulic motor (21). Said motor, as better outlined hereinafter, is supplied by a power transmission made up of an oil hydraulic circuit (22) under pressure, the pumps of such circuit being controlled by the rotor shaft (23) arranged in the nacelle of the system and coupled to the rotor itself. The energy thus produced is rectified by means of at least one rectifier (8) to the frequency of 50÷60 Hz and to the voltage of about 600 V and subsequently raised in voltage (range 20÷35 kV) by means of a main transformer (7′) arranged in the upper plane with respect to the generator. The electrical components are completed by a transformer for supplying auxiliary services (7″), from a control unit (24), a low (25) and high (26) voltage panel and electrical cable (18) which reaches the sea floor and extends towards the dry land or the sea substation. The power dissipated in heat which, as observed, mostly comes from the rectifier and from the main transformer, is discharged by means of several cooling systems. Firstly, there is the natural cooling due to the fact that the submerged body is surrounded by the sea water. Then, provided for was a cooling circuit intended for the rectifier (possibly, also a second circuit, similar to the previous one, for the main transformer) comprising a cooling unit (27), a hydraulic circuit (28) and a fresh water/sea water heat exchange unit (29). Lastly, there is also a forced air cooling unit comprising a fan (30) with a filter and ventilation pipe integrated therein (31). The is cool air is conveyed beneath the plane of the electrical machines, in the submerged body; the cool air is heated and due to the upward motion, as well as due to the assisted circulation (32), reaches the nacelle from which it exits after having created a slight overpressure.

Provided for in the lower part of the body (5) is a compartment (33) which can be filled with ballast with the aim of moving it further downwards towards the centre of gravity of the body and further enhance the stability of the system during the deep-sea transport and installation operations. The manufacturing concept provides for that the ballast be easily loadable and unloadable depending on the requirements and, therefore, provided for along the liquid ballast is the use of solid ballast, of the chain or metal rope type, capable of being loaded and unloaded by means of a pipe (34) and take up the delimited shape of the container compartment (33).

According to an alternative embodiment, the submerged body, in its lower portion, also contains a device known for the production of hydrogen, for example an electrolyser (63), at least one storage tank (64) and a pipe (65) for transporting hydrogen up to the dry land.

Referring to FIG. 4, the nacelle (4) forms the upper and aerial part of the system. Accommodated therein is a rotor group (2) integral with the two blades (3). The rotor is characterised in that it is possible to vary its speed of rotation, on the entire range of wind velocity, by adjusting the electric stall torque by means of the rectifier system, intervening on the stator circuit, to guarantee operation at maximum efficiency, from the rotor start-up up to the attainment of maximum power.

At the top, a rod-shaped lightning arrester (35) is arranged on the opposite side with respect to the blades for an “umbrella” protection of the entire structure against thunderbolts and it is made up of a sheath and electrical cable. Arranged beneath the cover of the nacelle is a monorail which, being capable of sliding along its axis, guided by a hydraulic jack (37), can take up the idle and maintenance position, when pushed forward the latter is arranged with its end outside the cover. This device is capable of moving the rotor portion (2a), when maintenance is required. As a matter of fact the rotor group is fixed to a cable which, guided by pulleys (36) of the monorail, passes through a trap door (38) of the nacelle support plane and reaches a winch (39) temporarily located in the work surface (40) anchored to the structure of the conversion system; thus the winch allows lowering the rotor from the nacelle to the plane of an underlying pontoon which transports it to a worksite for extraordinary maintenance. The maintenance of the components arranged in the submerged body is performed by using a pulley block (41) supported by a monorail located in the neck of the body submerged over the door (42) and accessible through the same. Also arranged in the nacelle are some components of two important subsystems: the subsystem for oil hydraulic transmission of power and the hydraulic yaw subsystem. In particular, arranged in the nacelle is the hydraulic pump group (43), mechanically drawn by the rotor shaft; such group, by means of its oil unit (44) and its rotating hydraulic joint (45), actuates the transmission of oil hydraulic power, through the hydraulic circuit which occurs between the level of the nacelle at the upper part and at the lower part in the core of the submerged body, to transfer the mechanical power of the rotor to the permanent magnet generator. The pump group (43) also supplies the yaw motors (46) arranged in proximity to the yaw bearing and related swivel ring (47). The yaw subsystem forms a first safety breaking system: such subsystem is supplied in a hydraulic manner, the related motors being supplied by the hydraulic pumps drawn by the rotor shaft, and it is, in safety conditions, controlled hydraulically. Consequently, also in s absence of electrical power, the rotor in motion operates the pumps which pressurise the circuit and move the motors which actuate the rotation of the nacelle at 90° with respect to the direction of the wind, thus substantially eliminating the velocity impact of the wind on the blades and, consequently, slowing the rotation of the rotor. A second safety breaking system is provided for by the possibility of partialising the power oil hydraulic, thus increasing the stall torque of the rotor thereof up to the complete blocking of the same.

In FIG. 5 shown is the coupling between the shaft and the rotor (48) and the hub (49) of the blades. The shaft is made up of a body (50) and a T-shaped head (51) coupled by means of a flanged joint (52). Interposed between the shaft and the hub is an elastic joint which has the purpose of protecting the shaft and the nacelle against load peaks due to the wind. Said joint is made up of two double “oscilating bushings” around their own axis (53′, 53″). Each bushing comprising a plurality of conical layers (54) made of elastomer and metal or composite material and two metal ends (53a′, 53b′, 53a″, 53b″) for coupling to the T-shaped head (51) and to the hub (49). The two bushings of each head of the T-shaped head are mounted one into the other, preloaded axially (X) on the bench, prior to installation, in such a manner to always guarantee the state of compression of the elastomer under the action of radial loads Y generated by the mechanical torque of the rotor. The assembly of the two bushings of each end is then mounted between the hub and the T-shaped head of the shaft with further axial preload (X) with the aim of balancing the axial load generated by the inherent weight of the rotor in rotation. Furthermore, arranged between the two bushings of each end is a metal ring (55) serving to limit the radial deformation of the bushings protecting the elastomer layer in case of excessive radial loads.

Additionally, given that the T-shaped head is separated from the body of the shaft, it is advantageous to fix the relative distance of the double bushings in such a manner that the radial load generated by the mechanical torque of the rotor is low enough, this also to the advantage of the reliability of these elastic joints. Lastly, shown in FIG. 6 is the detail of the joint between the blade and the hub. The blades (3)—two—are made up of a support structure made of glass fibre and/or carbon fibre and a shell still made of glass fibre and/or carbon fibre. The characteristic of these blades is that of having a support structure and a hub/blade joint adapted to tolerate, under safe conditions, the escape velocity of the rotor, this forming a third safety breaking system. The joint between the root of the blade and the hub is made by means of a ring insert with threaded holes (58), coupled to which are the screws for connecting to the hub and provided with carbon fibres arranged longitudinally (59). As observable from the sequence of drawings in FIG. 6, wound on the spindle of the support structure (60) are the first layers of glass or carbon fibre and resin (61), then the said ring insert with threaded holes (58) is arranged and lastly, the second layers of glass or carbon fibres and resin (62). In this manner, both the longitudinal and tangential arrangement of the fibres allows obtaining a combined resistant action both in axial and longitudinal direction, also in radial direction, ensuring the tightness of the blade root, insert, hub group.

In order to guarantee the safety and safeguard the entire installed system in case of harsh external conditions such as for example the occurrence of a strong turbulence or in case of very high waves, provided for is the use of a protection system aimed at monitoring the environmental and atmospheric conditions of the geographical are where the site in question is located and the conditions of the site itself. Such monitoring system provides for the use of a model for analysing the conditions of the geographical area where the site is located according to the relative data from the existing weather stations and at least two detection stations installed “ad hoc” in proximity to the site for the reliability of the forecast of possible unwanted phenomena. In case of emergency, the monitoring system identifies the hypothetical impending danger and intervenes by activating the procedure for blocking the entire system.

1) A system for converting wind energy in water deeper than 50 m, stabilised by means of blocked hydrostatic pressure, comprising a rotor group with a horizontal axis provided with two blades, accommodated in a nacelle, a permanent magnet generator, at least one transformer and at least one rectifier, and optionally further auxiliary components, a subsystem for anchoring the entire system to the sea floor, a subsystem for transmitting power from the rotor group to the generator and a subsystem for transmitting electrical power from the submerged body to dry land wherein the electrical energy generator, transformer, rectifier and said optional auxiliary components are located in a body submerged below the sea level.

2) The system according to claim 1, wherein the submerged body, which generates hydrostatic pressure required for stability of the system, comprises an engine room which accommodates the electrical generator, the transformers, the rectifier, the medium and low voltage panels and control panels.

3) The system according to claim 2, wherein said submerged body further comprises, in its upper part, a device for producing energy, at least one storage tank and a pipe for transporting hydrogen to dry land.

4) The system according to claim 1, wherein the rotor comprises two blades comprising fibres made of composite material arranged in a longitudinal and oblique direction with respect to a longitudinal axis of the blades, both in a support and a functional structure.

5) The system according to claim 4, wherein a joint between a root of a blade and a hub is rigid and includes a ring insert with threaded openings formed therein and is provided with carbon fibres arranged longitudinally.

6) The system according to claim 5, wherein the joint is an oscillating elastic joint comprising two double bushings which oscillate around their own axis.

7) The system according to claim 6, wherein each bushing comprises a plurality of conical layers made of elastomer and metal or composite material and two metal ends for coupling with a T-shaped head and with the hub.

8) The system according to claim 7, wherein a preload for the elastomer layers is provided for by inserting, with respect to each other, the bushings of each end of the T-shaped head and preloading them internally before installation.

9) The system according to claim 6, 7 or 8, wherein a metal ring is arranged between the two bushings of each end operable to limit radial deformations of the bushings protecting the elastomer layers.

10) The system according to claim 1, wherein the velocity of the rotor can be varied in such a manner to guarantee operation at the maximum efficiency, on the entire range of wind velocity, from start-up to maximum power.

11) The system according to claim 1, wherein the velocity of rotation of the rotor group is regulated by means of hydraulic yaw control supplied by at least one pump operated mechanically by a rotor shaft, said hydraulic yaw control comprising a first safety braking system which does not require electrical energy.

12) The system according to claim 1, wherein the transmission of power from the rotor to the electrical energy generator occurs through hydraulic transmission of power from at least one hydraulic pump, arranged at the level of the rotor, to at least one hydraulic motor arranged in the body submerged below the water level.

13) The system according to claim 12, wherein a circuit of the hydraulic transmission of power is used as a second safety braking system, for partialising the power circuit and thus increasing stall torque of the rotor.

14) The system according to claim 4, wherein the blade is provided with said support structure and a joint between the hub and blade adapted to tolerate, under safe conditions, an escape velocity of the rotor, thus forming a third safety braking system.

15) The system according to claim 1 comprising a rod-shaped lighting arrester mounted on the nacelle.

16) The system according to claim 1, wherein the hydrostatic pressure is blocked by an anchoring subsystem comprising a six-legged structure and elements anchored onto the sea floor.

17) The system according to claim 16, wherein the anchoring of the elements onto the sea floor is provided for by a plurality of blocks filled with ballast material and arranged in a steel template, surrounded both internally and externally by stones.

18) The system according to claim 16, wherein the anchoring subsystem comprises a single counterweight provided with at least one cavity.

19) The system according to claim 17, wherein the blocks comprise a cup-shaped configuration operable to be drawn to a site by floating.

20) The system according to claim 1, comprising a group for producing electrical energy comprising a permanent magnet generator driven by a hydraulic motor.

21) The system according to claim 1, wherein an electrical cable exiting from the submerged body is supported by a mechanical cable which is anchored to opposite blocks arranged on the sea floor.

22) The system according to claim 1, wherein a compartment in a lower part of the submerged body can be filled with ballast.

23) The system according to claim 22, wherein said ballast is made up of chains or metal ropes which pass through a pipe and take up the shape delimited by the compartment.

24) The system according to claim 1, comprising a system for monitoring the environmental and atmospheric conditions of a site comprising a model for analysing the conditions of the geographical area where the site is located according to relative data from existing weather stations and at least two detection stations installed in proximity to the site itself for the reliability of a forecast of harsh conditions.

25) A method for transporting towards a site and assembling a wind energy system according to claim 1 comprising the steps:
i. assembling at the site the platform, comprising hydraulic jacks and traction means wound inside respective seats, as well as in a relative base;
ii. moving the system described in step i towards a dock at such a depth to allow the installation of the wind energy system;
iii. moving the system identified by the preceding steps towards the identified site; and
iv. unloading the base onto the sea floor.

26) A device for mounting and dismounting the rotor of a system for converting wind in deep water in accordance with claim 1, comprising a monorail, arranged in the nacelle, moveable along an axis thereof by means of a hydraulic jack, fixed to said monorail being the pulleys for guiding and supporting a pulley, wherein on one side, a cable engages the rotor group and on the other side, through a trap door provided for in a support plane of the nacelle, reaching a winch arranged on a work surface anchored to the structure of the conversion system, allowing lowering the rotor from its operating position to an underlying support surface, and vice versa without requiring the use of crane vessels or pontoons.

27) The system according to claim 16, wherein the counterweight is operable to be drawn to a site by floating.
